(19) United States
(12) Patent Application Publication
(10) Pub. No.: US 2024/0276278 A1
(43) Pub. Date: Aug. 15, 2024

(54) TRANSMISSION OF MEASUREMENT DATA ASSOCIATED WITH LOCATION INFORMATION

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 18/641,177

(22) Filed: Apr. 19, 2024

Related U.S. Application Data
(63) Continuation of application No. PCT/CN2021/125408, filed on Oct. 21, 2021.

(51) Int. Cl. H04W 24/10; H04W 64/00

(52) U.S. Cl. CPC H04W 24/10; H04W 64/00

(57) ABSTRACT

In some wireless communication scenarios, a radio environment map (e.g. a channel map) may be constructed that associates measurement results with locations. To assist in generating or maintaining the map, one or more user equipments (UEs) may need to generate measurement data and report it along with associated location information. In some embodiments, a method may include a UE generating the measurement data that associates a measurement with location information associated with the UE. The method may further include the UE transmitting the measurement data carrying the location information to a radio access network (RAN) device for use by the RAN.

### CROSS-REFERENCE TO RELATED APPLICATIONS

This application is a continuation of International Application No. PCT/CN2021/125408, filed on Oct. 21, 2021, the disclosure of which is hereby incorporated by reference in its entirety.

### TECHNICAL FIELD

The present application relates to wireless communication, and more specifically to wireless transmission of measurement data that is associated with location information.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a UE may wirelessly transmit information to a TRP in an uplink communication over a particular frequency (or range of frequencies) for a particular duration of time. The frequency and time duration are examples of resources, typically referred to as time-frequency resources.

The TRPs are part of a radio access network (RAN), which is the network responsible for implementing wireless communication with the UEs over the air link. The quality of a wireless communication between a UE and one or more of the TRPs is dependent upon the quality of the wireless channel. The quality of the wireless channel is dependent upon many factors. These factors may include, for example, the location of the UE relative to the TRPs. For example, a UE located at a spot having direct line of sight (LOS) to a TRP may have a wireless channel of higher quality than a UE located at a spot that is not direct LOS and that is surrounded by tall buildings. A UE may measure one or more wireless channel parameters indicative of one or more properties of the wireless channel, and then provide the measurement result(s) back to the TRP. For example, the TRP may transmit a reference signal to the UE, and the UE may use the reference signal to measure channel state information (CSI). The measured CSI may then be transmitted back to the TRP.

### SUMMARY

Certain wireless channel parameters may be static or change only semi-statically for a particular location, e.g. because the TRP and the main obstructions (e.g. buildings) are stationary. For example, a parameter such as path loss or delay spread may have a value that remains constant (static) at a particular location for a particular duration of time, and is substantially the same for any UE that happens to be at that location during that particular duration of time. It may be a waste of overhead for each UE at that location to measure such wireless channel parameters and transmit the measurement results. Instead, in some embodiments, the RAN may construct a channel map that associates channel measurement results with locations. Once the channel map is constructed, upon receiving location information associated with a UE, the RAN can consult the channel map to obtain the channel information for that location, and hence the UE might not need to perform a measurement or return a measurement result. For example, the UE might not need to measure and report CSI. Overhead may therefore be saved.

However, to construct, maintain, and/or update a channel map, one or more UEs communicating with the TRPs of the RAN may need to generate measurement data and report it to the RAN along with associated location information. For example, a UE may transmit a coordinate indicative of its location (e.g. a GPS coordinate) along with CSI measured at that location. The location information is the coordinate, the CSI is a measurement result, and the measurement data is the combination of measurement result and location information. The measurement data may then be used by the RAN to construct or update the channel map at that location. Afterwards, that or another UE at the same location may then be able to refrain from measuring and reporting CSI. A new UE might only need to report its location to the RAN, upon which the RAN uses the channel map to obtain the CSI.

More generally, the RAN might construct a map of radio environment information that encompass more than just channel information, e.g. it may be more than just a channel map. For example, other or different parameters related to the environment might be measured by a UE and reported along with the location information associated with that UE, e.g. the UE might measure and report information such as humidity or air pollution. The reported information may be stored in the radio environment map and utilized.

In some embodiments, there is provided a method performed by an apparatus, such as a UE. The method may include generating measurement data that associates a measurement with location information associated with the apparatus. The method may further include transmitting the measurement data carrying the location information to a RAN device for use by the RAN. In some embodiments, a corresponding method is provided that is performed by a device in the RAN, e.g. such as a TRP in the RAN. The method may include receiving, from an apparatus (e.g. UE) that wirelessly communicates with the RAN, measurement data that associates a measurement that was performed by the apparatus with location information associated with the apparatus. The method may further include decoding the measurement data to obtain the location information and a measurement result of the measurement. In some embodiments, the method may further include using the location information and measurement result to construct or update a map, e.g. a channel map.

A technical benefit of some embodiments is the association of measurement results with location information, which may allow for the RAN to construct and/or update a radio environment map (e.g. a channel map) and thereby save communication overhead after the map has been constructed and/or updated, because other UEs might not need to transmit measurement feedback for that location.

In some scenarios, there may be technical challenges associated with implementing the reporting of a measured parameter and associated location information. For example, location information of a UE might be considered private. As another example, different UEs might have different capabilities, such that some UEs might be able to measure and report several different parameters for a location, whereas other UEs might be able to only measure and report one parameter for a location. Some embodiments address these technical challenges in the ways described herein. For example, in some embodiments an ID of the UE is not included with the transmission of the measurement data. The result is the technical benefit of better maintaining the privacy of the UE. As another example, in some embodiments a data format for the measurement data may be obtained, e.g. configured by the RAN for a UE or reported by the UE. For example, the UE may transmit an identifier (ID) that indicates, to the RAN, which one or more parameters are measured by the UE. Other configurations may include granularity of location size and/or granularity of the measurement data and/or number of locations in a measurement report carrying the measurement data, etc. This allows for the technical benefit of being able to accommodate different UEs having different capabilities, e.g. because different data formats may be configured for different UEs depending upon their capabilities.

Location, as used herein, refers to position in physical space, but it may also encompass orientation, depending upon the implementation. For example, two UEs at the same coordinates in physical space but having two different orientations might be considered as being at two different locations, depending upon the implementation.

Corresponding apparatuses and devices for performing the methods are also disclosed herein.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a UE communicating with a TRP, according to one embodiment;

FIG. 6 illustrates a method performed by the UE and TRP, according to one embodiment;

FIGS. 7 and 8 illustrate portions of space partitioned into different regions, according to various embodiments;

FIGS. 9 to 13 illustrate examples of data formats for measurement data, according to various embodiments; and

FIG. 14 illustrates a radio environment map maintained by a RAN, according to one embodiment.

### DETAILED DESCRIPTION OF ILLUSTRATIVE EMBODIMENTS

For illustrative purposes, specific example embodiments will now be explained in greater detail below in conjunction with the figures.

### Example Communication Systems and Devices

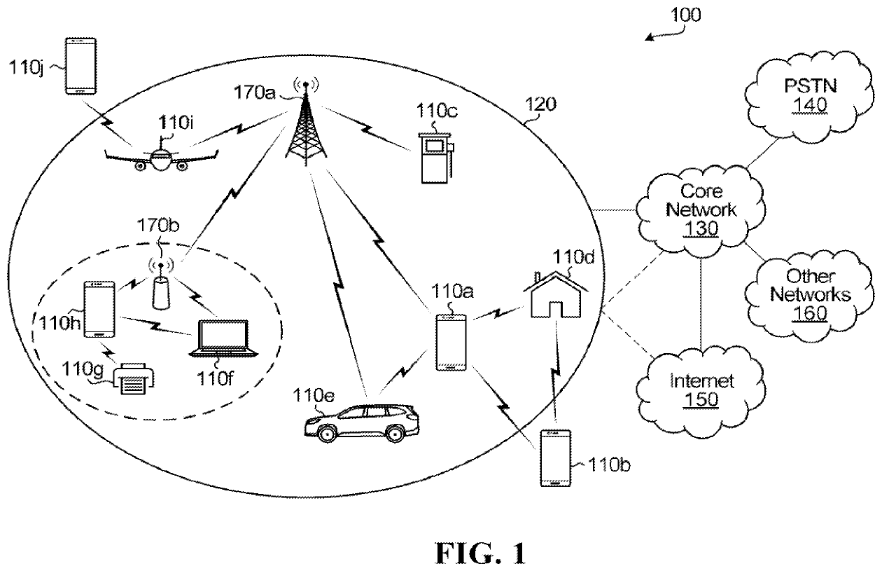

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

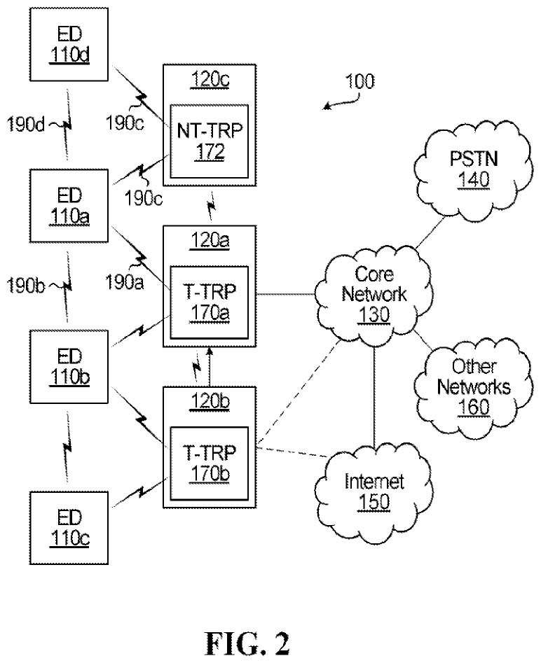

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

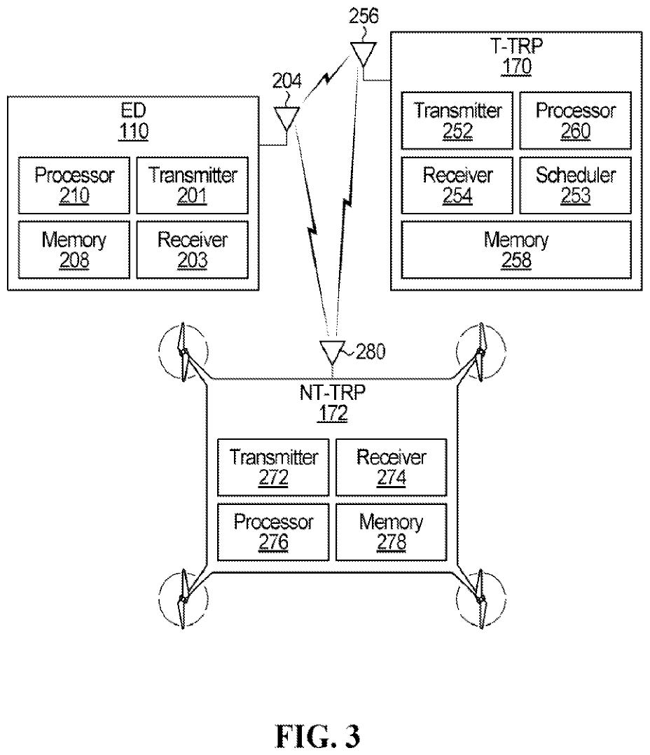

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IOT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

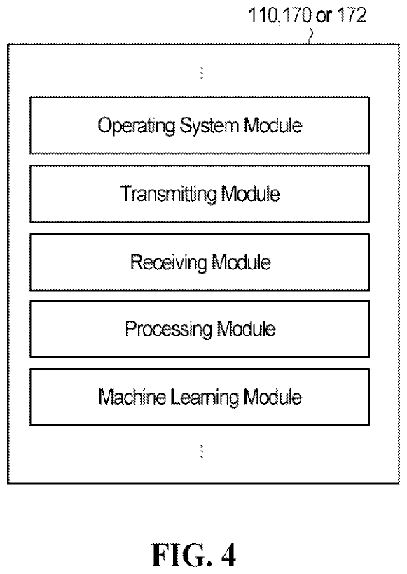

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

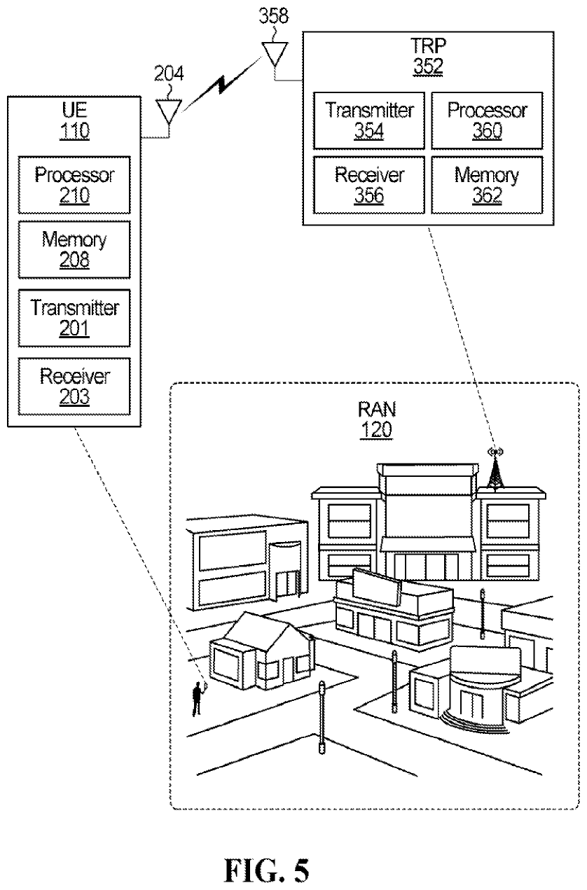

FIG. 5 illustrates an ED communicating with a TRP 352 in a RAN 120, according to one embodiment. The ED is illustrated as a UE, and will be referred to as UE 110. However, the ED does not necessarily need to be a UE.

The TRP 352 may be T-TRP 170 or NT-TRP 172. In some embodiments, the parts of the TRP 352 may be distributed. For example, some of the modules of the TRP 352 may be located remote from the equipment housing the antennas of the TRP 352, and may be coupled to the equipment housing the antennas over a communication link (not shown). Therefore, in some embodiments, the term TRP 352 may also refer to modules in the RAN 120 that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that: process (e.g. decode) measurement data from the UE 110; generate a message for transmission to the UE 110, e.g. a message configuring a data format for the measurement data; generate the downlink transmissions for initial access (e.g. SSBs); generate scheduled downlink transmissions; process uplink transmissions, etc. The modules may also be coupled to other TRPs. In some embodiments, the TRP 352 may actually be a plurality of TRPs that are operating together to serve UE 110, e.g. through coordinated multipoint transmissions.

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) the operations described herein as being performed by the TRP 352, e.g. decoding the measurement data received from the UE 110, generating messages configuring the UE 110 (e.g. configuring a data format for the measurement data), etc. Generation of messages for downlink transmission may include arranging the information in a message format, encoding the message, modulating, performing beamforming (as necessary), etc. Processing uplink transmissions may include performing beamforming (as necessary), demodulating and decoding the received messages, etc. Decoding the measurement data or any other received data may be performed by a decoding method that decodes according to a channel coding scheme, e.g. polar decoding if the data is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc. Although not illustrated, the processor 360 may form part of the transmitter 354 and/or receiver 356. The TRP 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

UE 110 includes antenna 204, processor 210, memory 208, transmitter 201, and receiver 203, as described earlier. The processor 210 performs (or controls the UE 110 to perform) much of the operations described herein as being performed by the UE 110, such as: measuring a parameter to obtain a measurement result, obtaining location information, generating measurement data (e.g. by incorporating the measurement result and the location information into a same message which acts as the measurement data), obtaining a data format for the measurement data (e.g. by deciding the format based on the capabilities of the UE 110 or by receiving the configuration in a message that is received and decoded to obtain the configuration), etc.

The processor 210 generates messages for uplink transmission (e.g. messages carrying measurement data), and the processor 210 processes received downlink transmissions. Generation of messages (e.g. measurement data) for uplink transmission may include arranging the information in a message format, encoding the message, modulating, performing beamforming (as necessary), etc. Processing received downlink transmissions may include performing beamforming (as necessary), demodulating and decoding the received messages, etc. Although not illustrated, the processor 210 may form part of the transmitter 201 and/or receiver 203.

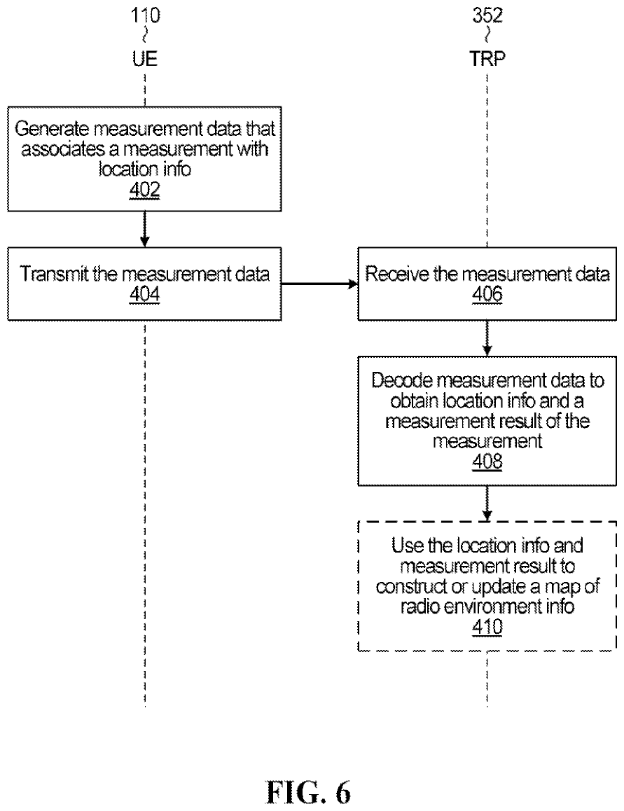

FIG. 6 illustrates a method performed by the UE 110 and TRP 352, according to one embodiment.

At step 402, the UE 110 generates measurement data that associates a measurement with location information associated with the UE 110. For example, the location information may be equal to the location of the UE 110, or associated with the location of the UE 110, or indicative of the location of the UE 110.

At step 404, the UE 110 transmits the measurement data carrying the location information to TRP 352 for use by the RAN 120.

At step 406, the TRP 352 receives the measurement data.

At step 408, the TRP 352 decodes the measurement data to obtain the location information and a measurement result of the measurement.

Optionally, at step 410, the TRP 352 uses the location information and measurement result to construct or update a map of radio environment information at that location, e.g. to update a channel map at the location.

Note that the measurement data in FIG. 6 is sometimes alternatively called a “measurement report”.

FIG. 6 may be modified to substitute an apparatus for UE 110, where the apparatus is an electronic device that might be a UE, but that does not necessarily need to be a UE. However, for ease of explanation, the remaining embodiments and variations of FIG. 6 will refer to UE 110 instead of an apparatus. Similarly, FIG. 6 may be modified to substitute TRP 352 for a RAN device, where the RAN device might be a TRP, but does not necessarily need to be a TRP. For example, the RAN device may be a server, node, or other processing device within RAN 120, e.g. in communication with the TRP 352 via a backhaul link or other link, in which case the TRP 352 may relay the measurement data to the RAN device. However, for ease of explanation, the remaining embodiments and variations of FIG. 6 will refer to TRP 352 instead of RAN device.

Note that in FIG. 6 the measurement data carrying the location information is for use by the RAN 120. It is not used by the core network 130 or another network outside the RAN 120. This is because the measurement result and associated location information are for use in relation to the air interface for wireless communication, e.g. for use to construct a radio environment map, such as a channel map. The location information is not forwarded on to the core network 130.

### Obtaining Location Information

In the method of FIG. 6, the measurement data carries location information associated with the UE 110. The location information may be obtained in different ways, some examples of which are discussed below.

In some embodiments, the location information may comprise at least one of: a coordinate representing a location of the UE 110 in space; an identifier of a region in which the UE 110 is located; or a geographic coordinate equal to or based on the coordinate. In some embodiments, the coordinate may be either an absolute coordinate or a relative coordinate that is relative to a reference location. In some embodiments, the geographic coordinate may comprise at least one of: an indication of latitude, longitude, and altitude; an indication of latitude and longitude; an indication of latitude and altitude; an indication of longitude and altitude; a geocode; or a global positioning system (GPS) coordinate. Some specific examples are provided below.

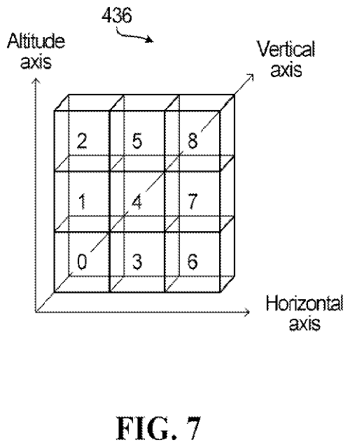

In some embodiments, a portion of space is partitioned into different regions. For example, FIG. 7 illustrates a portion of space 436 partitioned into nine regions, each associated with a respective different unique identifier. The identifiers are 0 to 8 in FIG. 7. Note that an identifier may alternatively be called by another name, such as a tag.

The regions in FIG. 7 are illustrated as non-overlapping and three-dimensional (3D). However, any embodiment illustrating regions as 3D and/or non-overlapping is just an example. Two-dimensional (2D) regions and/or partially overlapping regions may be implemented instead. Nine regions are shown in FIG. 7, but this is only an example. There may be more or fewer regions.

In the example in FIG. 7, the location information associated with UE 110 is the identifier of the region in which the UE 110 is located, e.g. one of the numbers 0 to 8. In some embodiments, the UE 110 determines its location, and based on the location the UE 110 knows the region 0 to 8 in which it is located. For example, region 0 may be associated with a known reference location, e.g. a particular GPS coordinate and/or the location of a particular TRP and/or a particular coordinate in a virtual 3D space, etc. The size of each region (e.g. the length, width, and height of each of regions 0 to 8) may also be known by the UE 110 and the TRP 352 (e.g. each region might be 2 metres by 2 metres by 2 metres). The number of regions and/or the reference location and/or the size of each region may be predefined or configured by the TRP 352 and/or configured by the UE 110, e.g. dynamically (e.g. in DCI) or semi-statically (e.g. in higher layer signaling, such as RRC signaling, or in a MAC CE). In one example, the TRP 352 indicates the following to the UE 110: (1) the orientation of the horizontal/vertical/altitude axis (if not predefined); (2) the number of regions in length, width, height; (3) the ID numbering rules for each region; and (4) the location of a reference region.

Note that the illustrated horizontal/vertical/altitude axis is only an example. In other embodiments, the horizontal/vertical/altitude axis might instead be a longitude/latitude/altitude axis, and/or the geographic north or magnetic north may be used for the vertical axis, etc.

The UE 110 determines its location and sends, as the location information, the region identifier of the region in which the UE 110 is located. For example, if the UE 110's location falls within region 1, the UE 110 transmits “1” as the location information carried by the measurement data in step 404 of FIG. 6.

Example ways in which the UE 110 may determine its location are as follows: (1) using GPS or assisted GPS; and/or (2) derived based on a measured angle and distance from a TRP; and/or (3) tracked from a previous position of the UE 110; and/or (4) with the assistance of a TRP (e.g. the TRP 352 may determine the location of the UE 110 and send that location to the UE 110); and/or (5) the UE 110 sensing its environment, e.g. using radio wave measurements (e.g. radar), and/or acoustic measurements (echolocation), and/or detecting Wi-Fi signals, and/or lidar measurements, e.g. the sensing may indicate the location or absence of obstructions in certain directions and/or certain distances from the UE, which may be indicative of a location or location information.

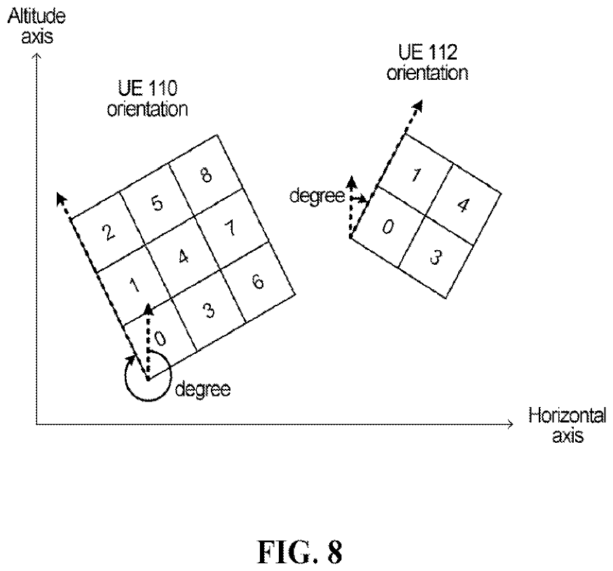

FIG. 8 illustrates a variation of FIG. 7 in which the orientation of the regions may be configured, possibly on a UE-by-UE basis. For example, in FIG. 8 the orientation in the vertical axis (not shown) is the same for all UEs, but UE 110 has a different orientation of its regions in the horizontal and altitude axes compared to another UE 112. A UE-specific orientation might be useful in some scenarios, e.g. if the UEs are moving, then the direction in which a UE moves might impact the wireless channel and therefore that might be better reflected by having regions aligned in relation to the direction of UE movement. In some embodiments, the orientation of the regions may be indicated by specifying an orientation that is a particular angle in the clockwise or counter clockwise direction around a reference axis (e.g. around the vertical axis in FIG. 8). In some embodiments, there may be a finite set of predefined different orientations, and the selected orientation of the finite set of orientations is signaled. In some embodiments, each UE 110 configures its region orientation by signaling the region orientation to the TRP 352.

As shown in FIG. 8, in some embodiments each UE may have its own local set of regions encompassing the space around that UE, rather than their being one big region used by several UEs. This is particularly beneficial if UEs are far apart and/or are configured with different region orientations. As also shown in FIG. 8, each UE does not necessarily need to have the same number of regions encompassing the space around the UE. For example, in FIG. 8 UE 110 has the nine regions introduced in FIG. 7, whereas UE 112 has only four regions. The number of regions may be configured by the UE 110 or the TRP 352.

As mentioned above, configuration is possible related to the regions. As an example, one or more of the following may be predefined or configured dynamically (e.g. in control information, such as DCI) or semi-statically (e.g. in higher layer signaling, such as RRC signaling, or in a MAC CE):
(1) Horizontal/vertical/altitude axis definition. For example, for a 3D axis, longitude/latitude/altitude may be configured for the three axes. As another example, geographic North/Magnetic North may be configured for vertical axis, geographic East/Magnetic East may be configured for horizontal axis, and altitude may be configured for the altitude axis.
(2) Length/width/height for each 3D region. For example, each region may be configured to be the same size (e.g. same volume) and that size may be configured.
(3) The number of regions in the direction of length, width, and/or height may be configured. For example, the number of regions in each of the horizontal axis, vertical axis, and altitude axis may be configured.
(4) The region ID numbering rules for each region may be configured. For example, as illustrated in FIG. 7, the ID may be numbered first from altitude axis, then horizontal axis, and last vertical axis. This is only one example.
(5) The location of a reference point or reference region may be configured, e.g. the detailed location of a reference point in a reference region (e.g. region 0). For example, the longitude/latitude/altitude for the center of region 0 may be configured.
(6) Orientation of grids, e.g. orientation relative to an axis may be configured, possibly on a UE-by-UE basis, like in the example explained above in relation to FIG. 8.

In some embodiments, the TRP 352 configures the regions (e.g. the TRP 352 configures one or more of the items of information (1) to (6) above) and transmits the indication of the configuration to the UE 110, either in DCI or in higher-layer signaling such as RRC signaling or in a MAC CE. In other embodiments, the UE 110 configures the regions (e.g. the UE 110 configures one or more of the items of information (1) to (6) above) and transmits the indication of the configuration to the TRP 352, either in UCI or higher-layer signaling such as RRC signaling or in a MAC CE. In some embodiments, some of the configuration of the regions is performed by the TRP 352, and other configuration of the regions is performed by UE 110. In some embodiments, the UE 110 reports its configuration preference to the TRP 352 and the TRP 352 performs the configuration of the regions for the UE 110, taking into account the configuration preferences. In some embodiments, the configuration of the regions may be on a UE-by-UE basis, or for a group of UEs.

Instead of the location information comprising an ID of a region, like in the examples of FIGS. 7 and 8, the location information may instead be a coordinate. The coordinate might or might not be a coordinate representative of a region. The coordinate may be a coordinate in a virtual space. The coordinate may be (or be based on) a geographic coordinate. For example, the location information may be a GPS coordinate or geocode representative of a location of the UE 110. Depending upon the implementation, the coordinate may indicate any one, some, or all of latitude, longitude, and altitude. In some embodiments, the coordinate may be an absolute coordinate, e.g. a GPS coordinate. In other embodiments, the coordinate may be a relative coordinate, e.g. relative to a reference location (such as a TRP) that is defined as (0, 0, 0), e.g. in a virtual coordinate system. In some embodiments, the location information may be a relative location from a reference location, such as a delta latitude, a delta longitude, and/or a delta altitude. The reference location may be configured by the TRP 352. Using coordinates, such as GPS, may be easier to implement than configuring regions like in the examples of FIGS. 7 and 8. However, location information in the form of a coordinate may require more bits to represent the location information in the measurement data compared to an ID indicating a region. Therefore, to save wireless communication overhead (e.g. make the transmitted measurement data have a smaller payload), an implementation similar to FIG. 7 or 8 may be deployed.

### Measured Parameters

In the method of FIG. 6, the UE 110 associates a measurement with the location information in the measurement data. Many different parameters may be measured by the UE 110, depending upon the implementation and the capabilities of the UE 110.

In some embodiments, the UE 110 may measure an environment parameter at the location of the UE 110, e.g. air quality, and/or pollution, and/or humidity, and/or barometric pressure, etc. The measurement result of the measurement of the environment parameter may be incorporated into the measurement data and associated with the location information of the UE 110.

In some embodiments, the UE 110 may also or instead measure a wireless channel parameter at the location of the UE 110, e.g. a large-scale parameter, a small-scale parameter, and/or a Doppler-domain parameter. The measurement result of the measurement of the wireless channel parameter may be incorporated into the measurement data and associated with the location information of the UE 110.

Examples of large-scale parameters that may possibly be measured include path loss and/or shadow fading value. Examples of small-scale parameters that may possibly be measured include: (1) delay-domain parameters, such as delay spread (e.g. average delay and/or maximum delay), and/or power delay profile, and/or number of multipath components, and/or coherence bandwidth; and/or (2) spatial-domain parameters, such as power azimuth spectrum, and/or angular spread, and/or coherence distance, and/or a beam specific measurement. Examples of Doppler-domain parameters that may possibly be measured include: Doppler shift, and/or Doppler spread, and/or Doppler Power Spectrum, and/or coherence time, and/or UE speed, and/or UE orientation. As discussed in more detail later, the large-scale and small-scale parameters may be independent of the UE and therefore their measurement results may be included in measurement data that does not carry a UE ID. Whereas the measurement result of a Doppler-domain parameter is typically UE-dependent and therefore those measurement results may be included in measurement data that does carry a UE ID.

If the measurement result is UE-dependent (e.g. Doppler information), the TRP 352 decodes the measurement data to obtain the measurement result and the UE ID, and then performs appropriate configuration for that UE. In one example: UE 110 uses a data channel (e.g. PUSCH) which is scrambled by an ID (e.g. a C-RNTI) to report the Doppler information, the TRP 352 receives and decodes the Doppler information, and then the TRP 352 configures the appropriate subcarrier spacing for the UE 110 to try to solve the Doppler shift problem.

In some embodiments, the measurements may be referred to as “sensing”. For example, the UEs may be considered as sensors moving through the environment and collecting measurements related to environment.

Different types of measurements may require different types of measurement techniques, depending upon the parameter being measured. For example, some measurements may be performed by radio-frequency (RF) sensing. In some instances, the UE 110 may transmit a radio signal and use echoes to perform a measurement. In some examples, the UE 110 may use a sensor on the UE 110 to perform a measurement, e.g. a humidity sensor for measuring humidity.

Performing some measurements may require receiving a signal from the RAN 120, e.g. from the TRP 352. As an example, TRP 352 may transmit to UE 110 a reference signal or a synchronization signal. An example of a reference signal is a channel state information (CSI) reference signal (CSI-RS). An example of a synchronization signal is a primary synchronization signal (PSS) and/or a secondary synchronization signal (SSS). The reference signal and/or synchronization signal may be used by the UE 110 to perform a measurement and thereby obtain a measurement result. Examples of possible measurements include: measuring CSI, such as information related to scattering, fading, power decay and/or signal-to-noise ratio (SNR) in the channel; and/or measuring signal-to-interference-plus-noise ratio (SINR), which is sometimes instead called signal-to-noise-plus-interference ratio (SNIR); and/or measuring Reference Signal Receive Power (RSRP); and/or measuring Reference Signal Receive Quality (RSRQ); and/or measuring channel quality, e.g. to obtain a channel quality indicator (CQI). Performing a measurement on a received signal may include extracting waveform parameters from the signal, such as (but not limited to) amplitude, frequency, noise and/or timing of the waveform. The result is a measurement result, e.g. the measurement result may be the measured SNR, SINR, RRSP, and/or RSRQ. The measurement result may then be associated with the location information of the UE 110 and transmitted together in the measurement data.

### Data Format for the Measurement Data

The measurement data transmitted by the UE 110 at step 404 of FIG. 6 may have different possible data formats, which may be configured by the UE 110 and/or the TRP 352. Some examples are provided below.

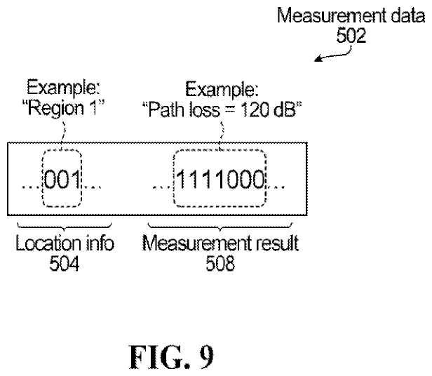

In some embodiments, the measurement data has a data format that at least includes a measurement result of a measurement and associated location information. The TRP 352 can therefore decode the measurement data to obtain the measurement result and the location information associated with that measurement result (e.g. the location at which the measurement was performed). For example, FIG. 9 illustrates a data format for measurement data 502 according to one embodiment. The measurement data 502 includes one or more bits providing a measurement result 508 of a measurement, as well as one or more other bits reporting the associated location information 504. The location information 504 may have any of the forms described herein. One example is illustrated in FIG. 9 in which the location information 504 is a series of bits that signals the ID of the region in which the UE 110 is located, e.g. “region 1”. The measurement result 508 may report the result of any measured parameter, e.g. one of the wireless channel parameters or environment parameters discussed herein. One example is illustrated in FIG. 9 in which the measurement result 508 is a series of bits that indicates the measured path loss at the location (in region 1), e.g. a path loss of 120 dB.

The measurement data 502 in FIG. 9 may possibly include other information, e.g. a UE ID, a parameter ID indicating which parameter or parameters were measured, etc. depending upon the implementation. Note that the measurement data 502 may alternatively be called a measurement report.

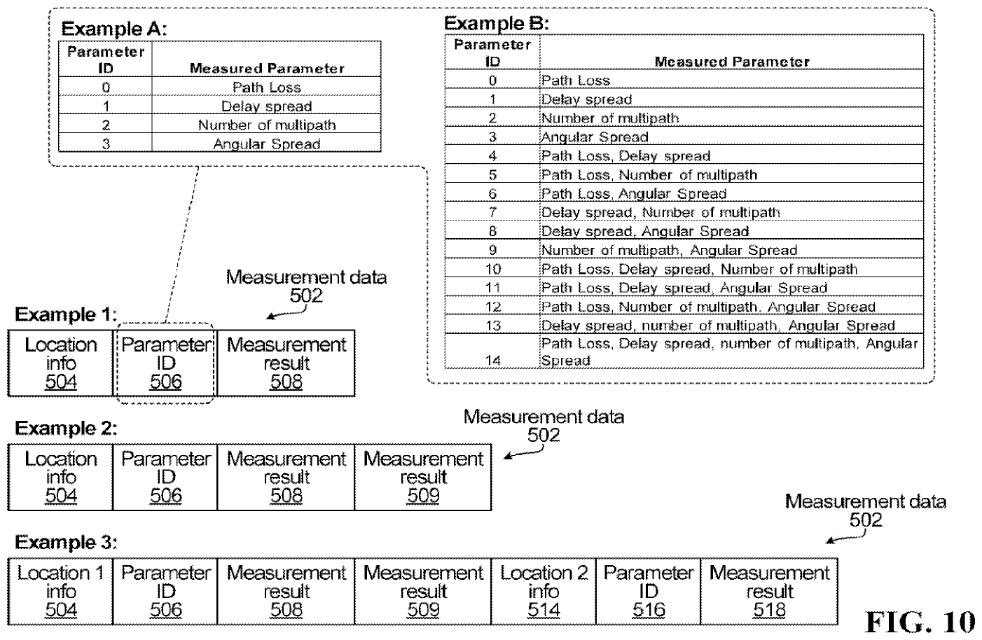

FIG. 9 is a generalization. Some specific example data formats for measurement data 502 are described in relation to FIGS. 10 to 13.

FIG. 10 illustrates examples of measurement data 502 each having a data format in which a field for ID information is included. The ID information is called the “parameter ID” in FIG. 10. In Example 1 of FIG. 10, the parameter ID 506 indicates to the TRP 352 a particular wireless channel parameter or particular environment parameter that was measured by the UE 110 and represented as the measurement result 508 in the measurement data 510. The association between parameter ID value and measured parameter may be predefined (e.g. in a standard) or configured in advance, e.g. either dynamically (such as in control information) or in semi-statically (such as in RRC signaling or in a MAC CE). Example A of FIG. 10 illustrates an example in which each parameter ID value is associated with a respective one measured parameter. For example, as per Example A, if parameter ID 506 equals 0, then this indicates to the TRP 352 that the measurement result 508 in the measurement data 502 is the measured path loss, whereas if the parameter ID 506 equals 1, then this indicates to the TRP 352 that the measurement result 508 is the measured data 502 is delay spread. Example B of FIG. 10 illustrates an example in which the parameter ID value may indicate one measured parameter or may indicate multiple measured parameters. If multiple measured parameters are measured, then the measurement data 502 carries multiple measurement results. For example, Example 2 of FIG. 10 illustrates an example in which the parameter ID 506 indicates multiple wireless channel parameters or environment parameters that are measured by the UE 110 and represented as multiple measurement results 508 and 509 in the measurement data 502. Each of the measurement results 508 and 509 corresponds to a respective different one of the multiple wireless channel parameters or environment parameters. In Example 2, measurement result 509 is included in addition to measurement result 508. Only two measurement results are illustrated, but there could be up to four measurement results if the table in Example Bis implemented. As an example, the parameter ID 506 in Example 2 might have the value “6”, in which case the measurement result 508 may be the measured path loss, and the measurement result 509 may be the measured angular spread. The order of the measurement results, e.g. whether measurement result 508 corresponds to path loss or angular spread, may be predefined or configured in advance, e.g. according to a rule.

Example 3 of FIG. 10 illustrates an example in which there are a plurality of parameter ID values 506 and 516, each one corresponding to a respective one or more measured parameters. Specifically, in Example 3 each parameter ID value is associated with a respective different location of the UE 110, e.g. a situation in which the UE 110 moves to different locations, takes one or more measurements per location, and then transmits a single measurement report (e.g. a single payload encoded together) carrying measurement data 502 for the multiple locations. Therefore, the measurement data 502 includes measurements for multiple locations, each location having associated location information, parameter ID, and one or more measurement results (depending upon the value of the parameter ID). Example 3 illustrates a specific scenario in which two measurements were taken at a first location (“location 1”) associated with location information 504. The results of the two measurement are respectively reported in measurement results 508 and 509. A single measurement was then taken at a second location (“location 2”) associated with location information 514. The result of that measurement is reported in measurement result 518. The number measurements taken at a location, and an identity of which one or more measurements were taken and are reported is indicated by the parameter ID. The number of locations covered in the payload of the measurement data 502 may be predefined or configured in advance, e.g. it may be limited to a maximum number of locations. Only two locations are shown in Example 3, but it could be more. In general, different measurements may be taken at different locations (e.g. delay spread is reported for one location and path loss is reported for another location), although this does not need to be the case. Note that location 2 is typically a different physical location from location 1, e.g. the UE 110 moved, although it could be in some situations that location 1 and location 2 happen to be the same location.

In an alternative to Example 3, there may be multiple measurement results in measurement data 502, all associated with a single location, and one or more of each of the multiple measurement results may be associated with a respective parameter ID. An example would be Example 3 modified to remove location 2 info 514, such that the location 1 is associated with multiple different measurements, identified by different parameter IDs 506 and 516.

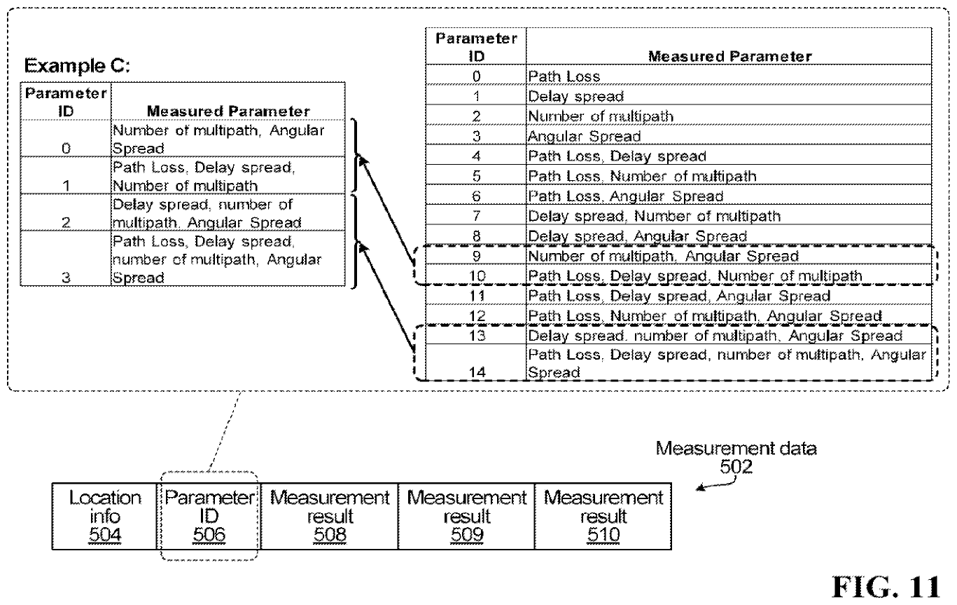

FIG. 11 illustrates a further example in which the parameter ID value may take on one of a smaller range of possible value, e.g. 0 to 3 in the illustrated example. However, the mapping of those values to measured parameters may be configured and changed dynamically or semi-statically. That is, there may be configured a mapping between each parameter ID value and the respective one or more measured parameters, and the mapping is one of a plurality of possible mappings that can be configured. The example mapping illustrated in FIG. 11 is one in which rows 9, 10, 13, and 14 of a larger set/table of measured parameters are respectively mapped to parameters ID values 0, 1, 2, and 3. Other mappings could be configured instead, and the mapping may be modified over time. The measurement data 502 in FIG. 11 illustrates three measurement results 508, 509, and 510 being reported, which means in this example either parameter ID value 1 or 2 is reported in the parameter ID 506 field, because those parameter ID values correspond to three measured parameters. The benefit of the example of FIG. 11 is that the overhead of the parameter ID remains small (e.g. two bits signaling one of four parameter ID values in the illustrated example), but different mappings between the bits and measured parameters may be configured, possibly on a UE-by-UE basis, e.g. depending upon the capabilities of the UE.

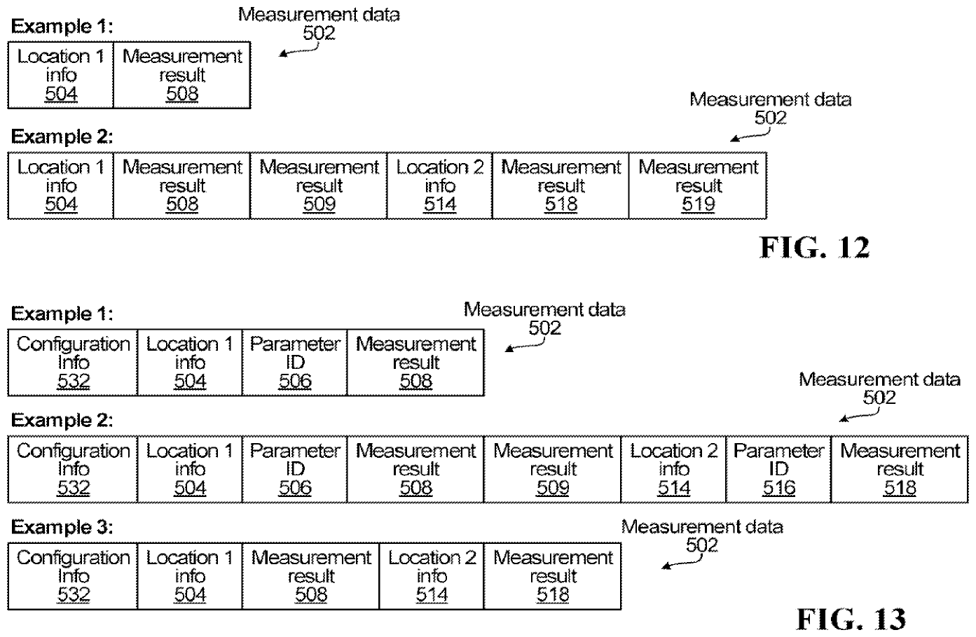

FIGS. 10 and 11 illustrate examples in which the ID information (the illustrated “parameter ID” field) is included in a same transmission as the measurement data 502, e.g. as part of the measurement data 502. For example, the parameter ID may be encoded together with the location information and the one or more measurement results, the encoded payload may then be transmitted by the UE 110 and decoded by the TRP 352 to extract the parameter ID, the location information, and the one or more measurement results. Alternatively, the parameter ID may be transmitted in a different transmission from the measurement data 502, e.g. transmitted by the UE 110 or the TRP 352 prior to the UE 110 transmitting the measurement data 502. For example, FIG. 12 illustrates two example data formats for the measurement data 502 in which there is no parameter ID. The parameter ID may be configured in advance, e.g. dynamically in control signaling or semi-statically in higher-layer signaling. The TRP 352 then knows in advance that when the one or more measurement results are received in the measurement data 502, the measurement results pertain to measured parameters that were previously identified by the parameter ID.

In an alternative embodiment, there might not be a parameter ID transmitted or configured, e.g. if the measured parameters are predefined, configured in advance in an initial transmission, or indicated on initial access.

In Example 1 of FIG. 12, the parameter ID configured in advance has a value that identifies one measured parameter that is measured per location, and the measurement data 502 only includes one location (“location 1”). In Example 2 of FIG. 12, the parameter ID configured in advance has a value that identifies two measured parameters that are measured per location, and the measurement data 502 happens to also include two locations (“location 1” and “location 2”). Therefore, for each location there are two measurement results: measurement results 508 and 509 associated with location 1, and measurement results 518 and 519 associated with location 2. In some embodiments, multiple parameter IDs may be configured in advance. For example, an initial transmission sent prior to sending measurement data 502 may indicate parameter ID values 0 and 1 from the table in Example A of FIG. 10 and thereby indicate to the TRP 352 that the subsequent measurement data 502 from the UE 110 will include two measurement results for a location, e.g. like is shown in Example 2 of FIG. 12. The order of the measurement results (e.g. the order in which the measurement results are concatenated in a payload) may be configured or predefined in advance based on a predefined rule. In one example, the predefined rule may be based on the parameter ID value, e.g. the lower ID value has its measurement results reported first. For example, measurement result 508 in Example 2 of FIG. 12 indicates the result of the path loss measurement at location 1, and measurement result 509 in Example 2 of FIG. 12 indicates the result of the delay spread measurement at location 1. This order is followed because path loss corresponds to parameter ID value 0 in the table shown in Example A of FIG. 10 and delay spread corresponds to parameter ID value 1 in the table shown in Example A of FIG. 10, and 0 is less than 1, hence path loss is reported first followed by delay spread for each location in the subsequent measurement data 502.

In some embodiments, the measurement data 502 may have a data format in which information is included in the measurement data 502 that configures the measurement data 502. For example, FIG. 13 includes three examples of measurement data 502 that all include configuration information 532. The configuration information 532 may be encoded together in a single payload with the location information and the one or more measurement results, and the encoded payload transmitted by the UE 110 in a same transmission and then received and decoded by the TRP 352. Examples of items that may be configured by the configuration information 532 may include any one, some, or all of the following:
(A) Granularity of a location size indicated by the location information. For example, the location information 504 may indicate “region 1”. The size of “region 1” may be configured in the configuration information 532, e.g. so that the UE 110 and TRP 352 know how big of an area/volume region 1 covers. In one example, each region may be configured to cover a large volume if the measurement relates to an environmental parameter such as air quality. There may be multiple region granularities predefined, each with a unique ID which may be signaled to indicate the granularity of location size. Multiple granularity of location sizes may be used, e.g. a larger granularity for environment information and a smaller granularity for wireless channel information.
(B) Granularity of the measurement data 502, such as the quantization level. For example, the configuration information 532 may indicate the bit length of the measurement result 508. The bit length may be configured appropriately depending upon: the capability of the UE 110, and/or the desired or mandated overhead (e.g. total number of bits for the measurement data 502), and/or the type of measurement (e.g. perhaps only one bit is needed for humidity in which bit value zero means below a certain humidity level and bit value one means above that humidity level). In one example, for path loss the granularity may be configured as one bit or two bits for reporting the measurement result, e.g. according to the following table:

| Bit length | Bit meaning |
|---|---|
| 1 | 0: path loss < Y1 dB |
| | 1: path loss ≥ Y1 dB |
| 2 | 00: path loss < X1 dB |
| | 01: X1 dB ≤ path loss < X2 dB |
| | 10: X2 dB ≤ path loss < X3 dB |
| | 11: path loss ≥ X3 dB |

A similar approach may be taken for configuring other measurement results.
(C) Number of locations in the measurement report carrying the measurement data 502. For example, in Example 1 of FIG. 13 the payload of the measurement data 502 pertains to one location (“location 1”), whereas in Example 2 of FIG. 13 the payload of the measurement data 502 pertains to two locations (“location 1” and “location 2”), each having its own associated one or more measurement results. The configuration information 532 may indicate how many locations are in the measurement data transmission, e.g. how many locations are encoded in a single payload.
(D) Maximum number of locations included in one transmitted measurement data payload.
(E) In some embodiments, the configuration information 532 may include the parameter ID indicating which one or more parameters are measured and reported for the one or more locations in that measurement data 502. For example, Example 3 of FIG. 13 does not include parameter ID 506 or parameter ID 516 because instead the configuration information 532 configures which parameter is measured at each location and reported in the measurement results 508 and 518. In one example, and assuming the table in Example A of FIG. 10, the configuration information 532 may indicate parameter ID={1, 2}, which means that the parameters to be measured are delay spread and number of multipath. As mentioned above, the order of the measurement results (e.g. the order in which the measurement results are concatenated in a payload) may be configured or predefined in advance based on a predefined rule.

The examples in FIG. 13 illustrate the configuration information 532 in the payload of the measurement data 502 itself, e.g. possibly in the first N bits of the measurement data 502. However, the configuration information 532 does not have to be present in the measurement data 502. For example, the UE 110 may transmit some or all of the configuration information prior to transmitting measurement data 502. In one example, the UE 110 sends a first transmission (e.g. first encoded payload) to the TRP 352. The first transmission includes configuration information, such as any one, some, or all of (A) to (E) outlined above. Subsequently, the UE 110 may transmit one or more measurement reports, each carrying measurement data 502 having a data format configured according to the information in the first transmission. In some embodiments, any one, some, or all of (A) to (E) outlined above may be predefined.

More generally, a measurement data configuration may be transmitted by the UE 110 to the TRP 352 or transmitted by the TRP 352 to the UE 110. The measurement data configuration may configure one or more of the items discussed above, e.g.: granularity of a location size indicated by the location information, and/or granularity of the measurement data, and/or number of locations in a measurement report carrying the measurement data, etc. The measurement data configuration may be received in the same transmission as the measurement data 502, e.g. part of the payload of the measurement data 502 carrying the measurement results, like in the examples in FIG. 13 in which configuration information 532 is included as part of the measurement data 502 payload. Alternatively, the measurement data configuration may be transmitted or received in a separate transmission, e.g. prior to transmission of the measurement data 502. The separate transmission may be in dynamic control signaling (e.g. in DCI or UCI). The separate transmission may instead be in semi-static control signaling (e.g. higher-layer signaling, such as RRC signaling or in a MAC CE).

As explained above, there are many different possible data formats for the measurement data, e.g. the example data formats in FIGS. 9 to 13. Therefore, in some embodiments in the method of FIG. 6, the method further includes the UE 110 and/or the TRP 352 obtaining the data format for the measurement data. The data format may include at least the location information. The data format may include the location information associated with at least one measurement result. The data format may be any one of the examples described above. However, the data format is not limited to the examples described above, and the data format might be such that the measurement data includes different or additional information. As one example, one or more of the example measurement data 502 in FIGS. 9 to 13 may also include a time stamp indicating when the measurement was taken and/or information related to the accuracy of a measurement result, etc. As another example, the granularity of a location and/or the granularity of a measurement result may be separately indicated for each location in the measurement data.

By configuring the data format of the measurement data, the bit meaning of the bits in the measurement data is known, e.g. the UE 110 and the TRP 352 know which fields correspond to which indications and the bit lengths of those fields. This enables correct decoding and extracting of the information from the received measurement data.

In some embodiments, the data format is obtained by the UE 110 by the UE determining the data format based on the capabilities of the UE 110. For example, a UE 110 that can measure a large variety of wireless channel and/or environment parameters may select a data format that accommodates the transmission of several measurement results, possibly associated with different locations, e.g. Example 3 of FIG. 10. The data format may have a parameter ID field that is configured to signal multiple different values mapped to multiple different combinations of measured parameters, e.g. Example B of FIG. 10. As another example, if the UE 110 is in a power saving mode or currently performing other intensive processing (e.g. machine learning training) the UE 110 may select a data format that results in a small payload, e.g. that accommodates the transmission of one measurement result per location. In some embodiments, the UE 110 dynamically determines which parameters and/or what parameters it is going to measure and transmit for a particular location, e.g. according to capability of the UE 110, mode of operation of the UE 110 (e.g. whether the UE 110 is in a power saving mode), etc. Different UEs may dynamically determine different parameter based on the capability of the UE, mode of operation of the UE, etc. For example, two UEs both being served by the TRP 352 may dynamically determine and measure and report different parameters that might or might not partially overlap.

The data format may be signaled by the UE 110 to the TRP 352 in different ways, e.g. in the measurement data itself (e.g. in configuration information 532), in separate dynamic control signaling (e.g. in UCI), in higher-layer signaling (e.g. RRC signaling) or in a MAC CE, etc. In some embodiments, the data format is obtained by the UE 110 by the UE 110 receiving an indication of the data format from the TRP 352.

In some embodiments, the data format is obtained by the TRP 352 by the TRP 352 selecting the data format, e.g. based on the capability of the UE 110, such as in response to information in a capability report sent from the UE 110. In some embodiments, a same data format is selected for a group of UEs served by the TRP 352, whereas in other embodiments the TRP 352 selects a suitable data format for each UE on a UE-by-UE basis. In some embodiments, the TRP 352 obtains the data format from the UE, e.g. like as explained above. If the TRP 352 is to select and transmit the indication of the data format to a UE, then the data format may be signalled by the TRP 352 in different ways, e.g. in dynamic control signaling (e.g. in DCI) or in higher-layer signaling (e.g. RRC signaling) or in a MAC CE, etc.

In some embodiments, the measurement data may be defined by the data format, e.g. the data format is configured to be able to carry measurement results of particular measurements, with perhaps the particular measurement being signaled by the parameter ID. The measurement data defined by the data format may include at least one of: environment information; channel information; measurement results corresponding to measured parameters that are configured by the RAN; or measurement results corresponding to measured parameters that are determined by the UE 110.

In some embodiments, the transmission including the measurement data in FIG. 6 (e.g. the transmission in step 404 of FIG. 6) might not include the ID of UE 110. For example, the measurement data 502 in the examples in FIGS. 9 to 13 do not illustrate a UE ID being included for UE 110. The omission of the UE ID provides the benefit of possibly increased privacy for UE 110. For example, the location information has an association with the location of the UE 110, and so transmitting the location information and UE ID discloses specifically which UE is at that location, which may be considered private. Many measured parameters do not require an identification of the UE, e.g. they may be independent of the UE and the same at that location regardless of the UE. For example, the large-scale and small-scale parameters discussed earlier may be independent of the UE and therefore their measurement results may be included in measurement data that does not carry a UE ID. However, some measured parameters (e.g. the Doppler-domain parameters discussed earlier) may be dependent upon the UE, in which case the measurement data may carry the UE ID of the UE transmitting the measurement data.

The measurement data transmitted in FIG. 6 (examples of which are shown in FIGS. 9 to 13) may be transmitted from the UE 110 in different manners. In some embodiments, the measurement data is transmitted in physical layer control signaling, e.g. as UCI in a control channel. In such embodiments, the control information carrying the measurement data may have its cyclic redundancy check (CRC) value scrambled by an ID, e.g. by performing an XOR operation between the CRC value and the ID. The ID may possibly be common to a group of UEs, e.g. an ID assigned to several UEs for transmitting measurement data, such as a group common radio network temporary identifier (RNTI), which may be predefined or indicated by the TRP 352. In other embodiments, the measurement data may be transmitted in a data channel, e.g. a PUSCH, in which case the transmission of the measurement data may possibly be scheduled, e.g. via a dynamic explicit scheduling grant. If the transmission is scheduled, the CRC value of the control information scheduling the measurement data in the data channel may be scrambled by an ID, e.g. by performing an XOR operation between the CRC value and the ID. The ID may possibly be common to a group of UEs, e.g. an ID assigned to several UEs for transmitting measurement data, such as a group common RNTI, which may be predefined or indicated by the TRP 352. A benefit of scheduling the measurement data 502 in the data channel is that it may be easier to accommodate measurement data 502 that is large and/or of variable size. A benefit of instead scheduling the measurement data 502 in a control channel is that it may result in less overhead because the TRP 352 can decode the control channel to obtain the measurement data 502 directly, rather than decoding the control channel to obtain the scheduling information for the measurement data 502, and then separately decoding the data channel to obtain the measurement data 502. In some embodiments, the measurement data 502 may be transmitted in a dedicated sensing/measurement feedback channel, which may be a control channel or a data channel. In some embodiments, the measurement data 502 may be transmitted in grant-free resources, rather than in a granted (scheduled) resource. If grant-free transmission is used on grant-free resources, the number of repetitions may be small (or there may be no repetitions) relative to other information transmitted on grant-free resources because the measurement data 502 might not be considered as critical.

In some embodiments, regardless of whether the measurement data is transmitted in a control channel or in a data channel, some or all of the measurement data itself may be scrambled. The scrambling may be performed by scrambling using an ID, e.g. by performing an XOR operation between the measurement data and the ID. The ID may possibly be common to a group of UEs, e.g. an ID assigned to several UEs for transmitting measurement data, such as a group common RNTI, which may be predefined or indicated by the TRP 352.

### Construction of a Radio Environment Map

As mentioned earlier, the measurement data explained above, e.g. transmitted by the UE 110 in FIG. 6, may be used by the TRP 352 to construct or update a radio environment map, such as a channel map. For example, in optional step 410 of FIG. 6 the TRP 352 uses the location information and measurement result for this purpose.

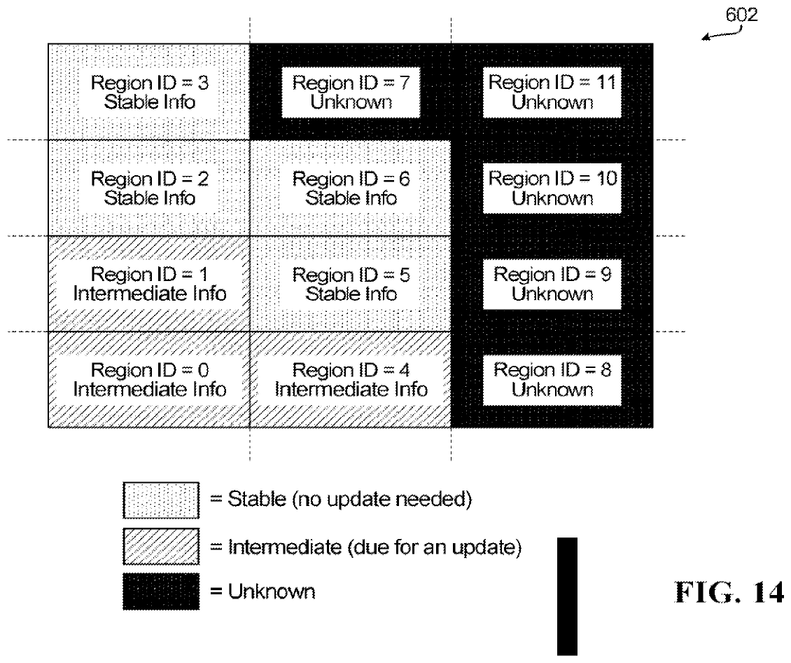

In some embodiments, the RAN 120 may maintain an integrated or global radio environment map that covers some or all of the regions served by the RAN 120. For example, FIG. 14 illustrates a radio environment map 602 maintained by a RAN 120 (e.g. stored at TRP 352), according to one embodiment. The radio environment map 602 includes twelve contiguous regions, labeled 0 to 11. For each region, radio environment information, such as environmental parameters and/or wireless channel parameters, is maintained. If the radio environment information is not known for a particular region, a label “Unknown” is assigned, as is the case for regions 7 to 11 in FIG. 14. If the radio environment information is only partially known or is stale for a particular region, a label “Intermediate” is assigned, as is the case for regions 0, 1, and 4 in FIG. 14. If the radio environment information is up-to-date and complete, a label “Stable” is assigned, as is the case for regions 2, 3, 5, and 6 in FIG. 14.

In some embodiments, the TRP 352 may only configure or request that a UE measure and send measurement data (e.g. steps 402 and 404 of FIG. 6) if the UE is in a region that is labeled “Intermediate” or “Unknown”, which may save overhead.

In some embodiments, the UE 110 may download the radio environment map 602 and only measure and send measurement data (e.g. steps 402 and 404 of FIG. 6) if the UE 110 is in a region that is labeled “Intermediate” or “Unknown”, which may save overhead.

Variations of FIG. 14 are possible. For example, the map 602 may have each region labelled either “stable” or “unstable”, and a UE 110 might only measure and transmit measurement data when in a region labelled “unstable”. As another example, the map 602 may assign each region a confidence or accuracy value associated with the measurement data currently possessed by the RAN 120 for that region. The confidence or accuracy value may reduce as the measurement data becomes stale, e.g. as the amount of time between when the measurement data was received and the current time grows. A UE 110 might only measure and transmit measurement data when in a region having a confidence or accuracy value that is below a certain threshold.

In some embodiments, even if the RAN 120 maintains a map 602, it might not influence how often UE 110 transmits measurement data. For example, the UE 110 may be configured to transmit measurement data once every N seconds, and/or when UE 110 moves, and the TRP 352 may decide to update the map 602 or ignore the received measurement data, e.g. if the map 602 does not need to be updated for that region.

### Examples

In view of, and in addition to the above, the following examples are disclosed.

Example 1: A method performed by an apparatus, the method comprising: generating measurement data that associates a measurement with location information associated with the apparatus; transmitting the measurement data carrying the location information to a radio access network (RAN) device for use by the RAN.

Example 2: The method of Example 1, further comprising obtaining a data format for the measurement data, wherein the data format comprises at least the location information.

Example 3: The method of Example 2, wherein the measurement data defined by the data format comprises at least one of: environment information; channel information; measurement results corresponding to measured parameters that are configured by the RAN; or measurement results corresponding to measured parameters that are determined by the apparatus.

Example 4: The method of any one of Examples 1 to 3, further comprising transmitting identifier (ID) information that indicates a particular wireless channel parameter or particular environment parameter that is measured by the apparatus and represented as a measurement result in the measurement data.

Example 5: The method of Example 4, wherein the particular wireless channel parameter is one of: a large scale parameter; a small scale parameter; or a Doppler-domain parameter.

Example 6: The method of Example 4 or Example 5, wherein the ID information is associated with one measured parameter.

Example 7: The method of Example 4 or Example 5, wherein the ID information indicates multiple wireless channel parameters or environment parameters that are measured by the apparatus and represented as multiple measurement results in the measurement data, wherein each of the measurement results corresponds to a respective different one of the multiple wireless channel parameters or environment parameters, and wherein the measurement result is included in the multiple measurement results.

Example 8: The method of any one of Examples 4 to 7, wherein the ID information comprises an ID value, the ID value being one of a plurality of ID values, and wherein each ID value of the plurality of ID values corresponds to a respective one or more measured parameters.

Example 9: The method of Example 8, wherein a mapping between each ID value and the respective one or more measured parameters is configured for the apparatus, and the mapping is one of a plurality of possible mappings that can be configured.

Example 10: The method of any one of Examples 4 to 9, wherein the ID information is included in a same transmission as the measurement data.

Example 11: The method of any one of Examples 4 to 9, wherein the ID information is transmitted in a different transmission from the measurement data and is transmitted prior to transmitting the measurement data.

Example 12: The method of any one of Examples 1 to 11, wherein a transmission including the measurement data does not include an ID of the apparatus.

Example 13: The method of any one of Examples 1 to 12, wherein the measurement data is transmitted in physical layer control signaling.

Example 14: The method of Example 13, wherein a cyclic redundancy check (CRC) of control information carrying the measurement data is scrambled by an ID common to a group of apparatuses.

Example 15: The method of any one of Examples 1 to 12, wherein the measurement data is transmitted in a data channel.

Example 16: The method of Example 15, wherein a CRC of control information scheduling the measurement data in the data channel is scrambled by an ID common to a group of apparatuses.

Example 17: The method of any one of Examples 1 to 12, wherein at least some of the measurement data is scrambled using an ID common to a group of apparatuses.

Example 18: The method of Example 14 or Example 16 or Example 17, wherein the ID common to the group of apparatuses is a group common radio network temporary identifier (RNTI).

Example 19: The method of any one of Examples 1 to 18, wherein a measurement data configuration is transmitted by the apparatus or received from the RAN, and the measurement data configuration configures at least one of: granularity of a location size indicated by the location information; granularity of the measurement data; or number of locations in a measurement report carrying the measurement data.

Example 20: The method of any one of Examples 1 to 19, wherein the location information comprises at least one of: a coordinate representing a location of the apparatus in space; an identifier of a region in which the apparatus is located; or a geographic coordinate equal to or based on the coordinate.

Example 21: The method of Example 20, wherein the coordinate is either an absolute coordinate or a relative coordinate that is relative to a reference location.

Example 22: The method of Example 20 or Example 21, wherein the geographic coordinate comprises at least one of: an indication of latitude, longitude, and altitude; an indication of latitude and longitude; an indication of latitude and altitude; an indication of longitude and altitude; a geocode; or a global positioning system (GPS) coordinate.

Example 23: An apparatus comprising: at least one processor; and a memory storing processor-executable instructions that, when executed, cause the at least one processor to: generate measurement data that associates a measurement with location information associated with the apparatus; output, for transmission to a radio access network (RAN) device for use by the RAN, the measurement data carrying the location information.

Example 24: The apparatus of Example 23, wherein the at least one processor is further to obtain a data format for the measurement data, wherein the data format comprises at least the location information.

Example 25: The apparatus of Example 24, wherein the measurement data defined by the data format comprises at least one of: environment information; channel information; measurement results corresponding to measured parameters that are configured by the RAN; or measurement results corresponding to measured parameters that are determined by the apparatus.

Example 26: The apparatus of any one of Examples 23 to 25, wherein the at least one processor is further to output, for transmission, identifier (ID) information that indicates a particular wireless channel parameter or particular environment parameter that is measured by the apparatus and represented as a measurement result in the measurement data.

Example 27: The apparatus of Example 26, wherein the particular wireless channel parameter is one of: a large scale parameter; a small scale parameter; or a Doppler-domain parameter.

Example 28: The apparatus of Example 26 or Example 27, wherein the ID information is associated with one measured parameter.

Example 29: The apparatus of Example 26 or Example 27, wherein the ID information indicates multiple wireless channel parameters or environment parameters that are measured by the apparatus and represented as multiple measurement results in the measurement data, wherein each of the measurement results corresponds to a respective different one of the multiple wireless channel parameters or environment parameters, and wherein the measurement result is included in the multiple measurement results.

Example 30: The apparatus of any one of Examples 26 to 29, wherein the ID information comprises an ID value, the ID value being one of a plurality of ID values, and wherein each ID value of the plurality of ID values corresponds to a respective one or more measured parameters.

Example 31: The apparatus of Example 30, wherein a mapping between each ID value and the respective one or more measured parameters is configured for the apparatus, and the mapping is one of a plurality of possible mappings that can be configured.

Example 32: The apparatus of any one of Examples 26 to 31, wherein the ID information is for inclusion in a same transmission as the measurement data.

Example 33: The apparatus of any one of Examples 26 to 31, wherein the ID information is for transmission in a different transmission from the measurement data and is for transmission prior to transmitting the measurement data.

Example 34: The apparatus of any one of Examples 23 to 33, wherein a transmission including the measurement data does not include an ID of the apparatus.

Example 35: The apparatus of any one of Examples 23 to 34, wherein the measurement data is for transmission in physical layer control signaling.

Example 36: The apparatus of Example 35, wherein a cyclic redundancy check (CRC) of control information carrying the measurement data is scrambled by an ID common to a group of apparatuses.

Example 37: The apparatus of any one of Examples 23 to 34, wherein the measurement data is for transmission in a data channel.

Example 38: The apparatus of Example 37, wherein a CRC of control information scheduling the measurement data in the data channel is scrambled by an ID common to a group of apparatuses.

Example 39: The apparatus of any one of Examples 23 to 34, wherein at least some of the measurement data is scrambled using an ID common to a group of apparatuses.

Example 40: The apparatus of Example 36 or Example 38 or Example 39, wherein the ID common to the group of apparatuses is a group common radio network temporary identifier (RNTI).

Example 41: The apparatus of any one of Examples 23 to 40, wherein a measurement data configuration is to be transmitted by the apparatus or received from the RAN, and the measurement data configuration configures at least one of: granularity of a location size indicated by the location information; granularity of the measurement data; or number of locations in a measurement report carrying the measurement data.

Example 42: The apparatus of any one of Examples 23 to 41, wherein the location information comprises at least one of: a coordinate representing a location of the apparatus in space; an identifier of a region in which the apparatus is located; or a geographic coordinate equal to or based on the coordinate.

Example 43: The apparatus of Example 42, wherein the coordinate is either an absolute coordinate or a relative coordinate that is relative to a reference location.

Example 44: The apparatus of Example 42 or Example 43, wherein the geographic coordinate comprises at least one of: an indication of latitude, longitude, and altitude; an indication of latitude and longitude; an indication of latitude and altitude; an indication of longitude and altitude; a geocode; or a global positioning system (GPS) coordinate.

Example 45: The apparatus of any one of Examples 23 to 44, wherein the apparatus is a user equipment (UE) that wirelessly communicates with the RAN.

Example 46: A method performed by a device in a radio access network (RAN), the method comprising: receiving, from an apparatus that wirelessly communicates with the RAN, measurement data that associates a measurement that was performed by the apparatus with location information associated with the apparatus; decoding the measurement data to obtain the location information and a measurement result of the measurement.

Example 47: The method of Example 46, further comprising obtaining a data format for the measurement data, wherein the data format comprises at least the location information.

Example 48: The method of Example 47, wherein the measurement data defined by the data format comprises at least one of: environment information; channel information; measurement results corresponding to measured parameters that are configured by the RAN; or measurement results corresponding to measured parameters that are determined by the apparatus.

Example 49: The method of any one of Examples 46 to 48, further comprising receiving identifier (ID) information that indicates a particular wireless channel parameter or particular environment parameter that was measured by the apparatus and represented as the measurement result in the measurement data.

Example 50: The method of Example 49, wherein the particular wireless channel parameter is one of: a large scale parameter; a small scale parameter; or a Doppler-domain parameter.

Example 51: The method of Example 49 or Example 50, wherein the ID information is associated with one measured parameter.

Example 52: The method of Example 49 or Example 50, wherein the ID information indicates multiple wireless channel parameters or environment parameters that were measured by the apparatus and are represented as multiple measurement results in the measurement data, wherein each of the measurement results corresponds to a respective different one of the multiple wireless channel parameters or environment parameters, and wherein the measurement result is included in the multiple measurement results.

Example 53: The method of any one of Examples 49 to 52, wherein the ID information comprises an ID value, the ID value being one of a plurality of ID values, and wherein each ID value of the plurality of ID values corresponds to a respective one or more measured parameters.

Example 54: The method of Example 53, wherein a mapping between each ID value and the respective one or more measured parameters is configured, and the mapping is one of a plurality of possible mappings that can be configured.

Example 55: The method of any one of Examples 49 to 54, wherein the ID information is received in a same transmission as the measurement data.

Example 56: The method of any one of Examples 49 to 54, wherein the ID information is received in a different transmission from the measurement data and is received prior to receiving the measurement data.

Example 57: The method of any one of Examples 46 to 56, wherein a transmission including the measurement data does not include an ID of the apparatus.

Example 58: The method of any one of Examples 46 to 57, wherein the measurement data is received in physical layer control signaling.

Example 59: The method of Example 58, wherein a cyclic redundancy check (CRC) of control information carrying the measurement data is scrambled by an ID common to a group of apparatuses.

Example 60: The method of any one of Examples 46 to 57, wherein the measurement data is received in a data channel.

Example 61: The method of Example 60, wherein a CRC of control information scheduling the measurement data in the data channel is scrambled by an ID common to a group of apparatuses.

Example 62: The method of any one of Examples 46 to 57, wherein at least some of the measurement data is scrambled using an ID common to a group of apparatuses.

Example 63: The method of Example 59 or Example 61 or Example 62, wherein the ID common to the group of apparatuses is a group common radio network temporary identifier (RNTI).

Example 64: The method of any one of Examples 46 to 63, wherein a measurement data configuration is transmitted by the RAN or received from the apparatus, and the measurement data configuration configures at least one of: granularity of a location size indicated by the location information; granularity of the measurement data; or number of locations in a measurement report carrying the measurement data.

Example 65: The method of any one of Examples 46 to 64, wherein the location information comprises at least one of: a coordinate representing a location of the apparatus in space; an identifier of a region in which the apparatus is located; or a geographic coordinate equal to or based on the coordinate.

Example 66: The method of Example 65, wherein the coordinate is either an absolute coordinate or a relative coordinate that is relative to a reference location.

Example 67: The method of Example 65 or Example 66, wherein the geographic coordinate comprises at least one of: an indication of latitude, longitude, and altitude; an indication of latitude and longitude; an indication of latitude and altitude; an indication of longitude and altitude; a geocode; or a global positioning system (GPS) coordinate.

Example 68: A device for deployment in a radio access network (RAN), the device comprising: at least one processor; and a memory storing processor-executable instructions that, when executed, cause the at least one processor to: receive, from an apparatus that wirelessly communicates with the RAN, measurement data that associates a measurement that was performed by the apparatus with location information associated with the apparatus; decode the measurement data to obtain the location information and a measurement result of the measurement.

Example 69: The device of Example 68, wherein the at least one processor is further to obtain a data format for the measurement data, wherein the data format comprises at least the location information.

Example 70: The device of Example 69, wherein the measurement data defined by the data format comprises at least one of: environment information; channel information; measurement results corresponding to measured parameters that are configured by the RAN; or measurement results corresponding to measured parameters that are determined by the apparatus.

Example 71: The device of any one of Examples 68 to 70, wherein the at least one processor is further to receive identifier (ID) information that indicates a particular wireless channel parameter or particular environment parameter that was measured by the apparatus and represented as the measurement result in the measurement data.

Example 72: The device of Example 71, wherein the particular wireless channel parameter is one of: a large scale parameter; a small scale parameter; or a Doppler-domain parameter.

Example 73: The device of Example 71 or Example 72, wherein the ID information is associated with one measured parameter.

Example 74: The device of Example 71 or Example 72, wherein the ID information indicates multiple wireless channel parameters or environment parameters that were measured by the apparatus and are represented as multiple measurement results in the measurement data, wherein each of the measurement results corresponds to a respective different one of the multiple wireless channel parameters or environment parameters, and wherein the measurement result is included in the multiple measurement results.

Example 75: The device of any one of Examples 72 to 74, wherein the ID information comprises an ID value, the ID value being one of a plurality of ID values, and wherein each ID value of the plurality of ID values corresponds to a respective one or more measured parameters.

Example 76: The device of Example 75, wherein a mapping between each ID value and the respective one or more measured parameters is configured, and the mapping is one of a plurality of possible mappings that can be configured.

Example 77: The device of any one of Examples 71 to 76, wherein the ID information is to be received in a same transmission as the measurement data.

Example 78: The device of any one of Examples 71 to 76, wherein the ID information is to be received in a different transmission from the measurement data and is to be received prior to receiving the measurement data.

Example 79: The device of any one of Examples 68 to 78, wherein a transmission including the measurement data does not include an ID of the apparatus.

Example 80: The device of any one of Examples 68 to 79, wherein the measurement data is to be received in physical layer control signaling.

Example 81: The device of Example 80, wherein a cyclic redundancy check (CRC) of control information carrying the measurement data is scrambled by an ID common to a group of apparatuses.

Example 82: The device of any one of Examples 68 to 79, wherein the measurement data is to be received in a data channel.

Example 83: The device of Example 82, wherein a CRC of control information scheduling the measurement data in the data channel is scrambled by an ID common to a group of apparatuses.

Example 84: The device of any one of Examples 68 to 79, wherein at least some of the measurement data is scrambled using an ID common to a group of apparatuses.

Example 85: The device of Example 81 or Example 83 or Example 84, wherein the ID common to the group of apparatuses is a group common radio network temporary identifier (RNTI).

Example 86: The device of any one of Examples 68 to 85, wherein a measurement data configuration is to be transmitted by the RAN or received from the apparatus, and the measurement data configuration configures at least one of: granularity of a location size indicated by the location information; granularity of the measurement data; or number of locations in a measurement report carrying the measurement data.

Example 87: The device of any one of Examples 68 to 86, wherein the location information comprises at least one of: a coordinate representing a location of the apparatus in space; an identifier of a region in which the apparatus is located; or a geographic coordinate equal to or based on the coordinate.

Example 88: The device of Example 87, wherein the coordinate is either an absolute coordinate or a relative coordinate that is relative to a reference location.

Example 89: The device of Example 87 or Example 88, wherein the geographic coordinate comprises at least one of: an indication of latitude, longitude, and altitude; an indication of latitude and longitude; an indication of latitude and altitude; an indication of longitude and altitude; a geocode; or a global positioning system (GPS) coordinate.

Example 90: The device of any one of claims 68 to 89, wherein the device is a network device.

Example 91: The device of Example 90, wherein the network device is a transmit-and-receive point (TRP).

Various methods are disclosed herein. Examples of an apparatus (e.g. ED or UE) and a device (e.g. TRP) to perform the various methods described herein are also disclosed.

The apparatus (e.g. UE 110) may include a memory to store processor-executable instructions, and at least one processor to execute the processor-executable instructions. When the processor executes the processor-executable instructions, the processor may be caused to directly perform or cause the apparatus to perform the method steps of the apparatus as described herein, e.g. the steps performed by UE 110 in FIG. 6. As one example, the processor may generate the measurement data that associates a measurement with location information, and may output the measurement data for transmission. The measurement data may be generated by the processor encoding a payload that includes both bits representing the measurement result of the measurement and bits representing the measurement location, thereby associating the measurement and the location information. The encoding may be performed by applying any error control coding algorithm, e.g. polar coding or LDPC coding, etc. The measurement data may be output for transmission by outputting, from the processor, the bits representing the measurement data. The bits are then transmitted by the transmitter.

The device (e.g. TRP 352) may include a memory to store processor-executable instructions, and at least one processor to execute the processor-executable instructions. When the processor executes the processor-executable instructions, the processor may be caused to directly perform or cause the device to perform the method steps of the device as described above, e.g. the method steps performed by the TRP 352 in FIG. 6. For example, the processor may receive measurement data that associates a measurement that was performed with location information. The measurement data may be received by receiving it at the input of the processor. The measurement data may originate from an apparatus that wirelessly communicates with the RAN. As another example, the processor may decode the measurement data to obtain the location information and a measurement result of the measurement.

Benefits of some embodiments herein include the following. The ability for a UE to report a measurement result associated with location information, which may allow for the RAN to construct and/or update a radio environment map (e.g. a channel map) and thereby save communication overhead after the map has been constructed and/or updated, because other UEs might not need to transmit measurement feedback for that location. The specific parameters measured and/or the number of measured parameters may be determined possibly dynamically and possibly on a UE-by-UE basis, thereby complementing a network having several UEs of different capabilities. The UE ID may possibly be omitted to help preserve privacy of the UE. Some embodiments herein differ from previous protocols in which the network configures a UE to measure certain parameters (e.g. measure a reference signal and report CSI), and the UE cannot self-determine which parameters it will measure and the UE must include the UE ID in the transmission and the transmission is limited to the control channel. In these previous measurement protocols there is also no reporting of location information. Further, in these previous protocols the information in the data channel is forwarded from the RAN to another network (e.g. a core network), rather than being used by the RAN. In some embodiments herewith, the measurement data carrying the location information is for use by the RAN, even if the measurement data is carried in a data channel. It is not used by the core network or another network outside the RAN. This is because the measurement result and associated location information are for use in relation to the air interface for wireless communication, e.g. for use to construct a radio environment map, such as a channel map.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

What is claimed is:

1. A method performed by an apparatus, the method comprising:
generating measurement data that associates a measurement with location information associated with the apparatus; and
transmitting the measurement data carrying the location information to a device in a radio access network (RAN) device for use by the RAN.

2. The method of claim 1, further comprising:
obtaining a data format for the measurement data, wherein the data format comprises at least the location information.

3. The method of claim 2, wherein the measurement data defined by the data format indicates at least one of:
environment information;
channel information;
first measurement results corresponding to first measured parameters that are configured by the RAN; or
second measurement results corresponding to second measured parameters that are determined by the apparatus.

4. The method of claim 1, further comprising:
transmitting identifier (ID) information that indicates a particular wireless channel parameter measured by the apparatus or a particular environment parameter measured by the apparatus, the particular wireless channel parameter or the particular environment parameter represented as a measurement result in the measurement data.

5. The method of claim 1, wherein the measurement data is transmitted in physical layer control signaling.

6. The method of claim 5, wherein a cyclic redundancy check (CRC) of control information carrying the measurement data is scrambled by an ID common to a group of apparatuses.

7. The method of claim 1, wherein the measurement data is transmitted in a data channel.

8. The method of claim 7, wherein a CRC of control information scheduling the measurement data in the data channel is scrambled by an ID common to a group of apparatuses.

9. The method of claim 1, wherein a measurement data configuration is transmitted by the apparatus or received from the RAN, and the measurement data configuration indicates at least one of:
first granularity of a location size indicated by the location information;
second granularity of the measurement data; or
a number of locations in a measurement report carrying the measurement data.

10. The method of claim 1, wherein the location information indicates at least one of:
a coordinate representing a location of the apparatus in space;
an identifier of a region in which the apparatus is located; or
a geographic coordinate equal to or based on the coordinate.

11. An apparatus comprising:
at least one processor; and
a memory storing processor-executable instructions that, when executed by the at least one processor, cause the apparatus to perform operations including:
generating measurement data that associates a measurement with location information associated with the apparatus; and
outputting, for transmission to a device in a radio access network (RAN) for use by the RAN, the measurement data carrying the location information.

12. The apparatus of claim 11, the operations further comprising:
obtaining a data format for the measurement data, wherein the data format comprises at least the location information.

13. The apparatus of claim 12, wherein the measurement data defined by the data format indicates at least one of:
environment information;
channel information;
first measurement results corresponding to first measured parameters that are configured by the RAN; or
second measurement results corresponding to second measured parameters that are determined by the apparatus.

14. The apparatus of claim 11, the operations further comprising:
outputting, for transmission, identifier (ID) information that indicates a particular wireless channel parameter measured by the apparatus or a particular environment parameter measured by the apparatus, the particular wireless channel parameter or the particular environment parameter represented as a measurement result in the measurement data.

15. The apparatus of any one of claim 11, wherein the measurement data is for transmission in physical layer control signaling.

16. The apparatus of claim 15, wherein a cyclic redundancy check (CRC) of control information carrying the measurement data is scrambled by an ID common to a group of apparatuses.

17. The apparatus of any one of claim 11, wherein the measurement data is for transmission in a data channel.

18. The apparatus of claim 17, wherein a CRC of control information scheduling the measurement data in the data channel is scrambled by an ID common to a group of apparatuses.

19. The apparatus of claim 11, wherein a measurement data configuration is to be transmitted by the apparatus or received from the RAN, and the measurement data configuration indicates at least one of:
first granularity of a location size indicated by the location information;
second granularity of the measurement data; or
a number of locations in a measurement report carrying the measurement data.

20. The apparatus of claim 11, wherein the location information indicates at least one of:
a coordinate representing a location of the apparatus in space;
an identifier of a region in which the apparatus is located; or
a geographic coordinate equal to or based on the coordinate.

21. A method performed by a device in a radio access network (RAN), the method comprising:
receiving, from an apparatus that wirelessly communicates with the RAN, measurement data that associates a measurement that was performed by the apparatus with location information associated with the apparatus; and
decoding the measurement data to obtain the location information and a measurement result of the measurement.

22. The method of claim 21, further comprising:
obtaining a data format for the measurement data, wherein the data format comprises at least the location information.

23. The method of claim 22, wherein the measurement data defined by the data format indicates at least one of:
environment information;
channel information;
first measurement results corresponding to first measured parameters that are configured by the RAN; or
second measurement results corresponding to second measured parameters that are determined by the apparatus.

24. The method of claim 21, further comprising:
receiving identifier (ID) information that indicates a particular wireless channel parameter measured by the apparatus or a particular environment parameter measured by the apparatus, the particular wireless channel parameter or the particular environment parameter represented as the measurement result in the measurement data.

25. The method of claim 24, wherein the particular wireless channel parameter is one of: a large scale parameter; a small scale parameter; or a Doppler-domain parameter.

26. A device for deployment in a radio access network (RAN), the device comprising:
at least one processor; and
a memory storing processor-executable instructions that, when executed by the at least one processor, cause the device to perform operations including:
receiving, from an apparatus that wirelessly communicates with the RAN, measurement data that associates a measurement that was performed by the apparatus with location information associated with the apparatus; and
decoding the measurement data to obtain the location information and a measurement result of the measurement.

27. The device of claim 26, the operations further comprising:
obtaining a data format for the measurement data, wherein the data format comprises at least the location information.

28. The device of claim 27, wherein the measurement data defined by the data format indicates at least one of:
environment information;
channel information;
first measurement results corresponding to first measured parameters that are configured by the RAN; or
second measurement results corresponding to second measured parameters that are determined by the apparatus.

29. The device of claim 26, the operations further comprising:
receiving identifier (ID) information that indicates a particular wireless channel parameter measured by the apparatus or a particular environment parameter measured by the apparatus, the particular wireless channel parameter or the particular environment parameter represented as the measurement result in the measurement data.

30. The device of claim 29, wherein the particular wireless channel parameter is one of: a large scale parameter; a small scale parameter; or a Doppler-domain parameter.
